(19) United States
(12) Patent Application Publication
(10) Pub. No.: US 2007/0029778 A1
(43) Pub. Date: Feb. 8, 2007

(54) NOTEBOOK WITH ROTATABLY MOUNTED PAGES AND METHODS OF MANUFACTURE AND USE

(75) Inventors: Alana Marie Deines, Seattle, WA (US); William Wells McNair, Redmond, WA (US)

Correspondence Address: DARBY & DARBY P.C., P. O. BOX 5257, NEW YORK, NY, 10150-5257, US

(73) Assignee: McNair & Deines LLC, Seattle, WA (US)

(21) Appl. No.: 11/457,127

(22) Filed: Jul. 12, 2006

Related U.S. Application Data
(60) Provisional application No. 60/698,777, filed on Jul. 12, 2005.

(51) Int. Cl. B42D 1/00

(52) U.S. Cl. 281/21.1

(57) ABSTRACT

A notebook includes a cover having a front side and a plurality of pages disposed within the cover and rotatably coupled to the cover so that the pages can be at least partially rotated out of the cover. The front side of the cover defines a cutout that exposes a portion of the pages to allow a user to selectively engage at least one of the pages to rotate that page outside the cover.

### CROSS-REFERENCE TO RELATED APPLICATIONS

This application claims the benefit under 35 USC 119(e) of U.S. Provisional Patent Application Ser. No. 60/698,777, filed on Jul. 12, 2005, which is herein incorporated by reference.

### FIELD

The invention is directed to a notebook and methods of making and using the notebook. The invention is also directed to a notebook with pages rotatably mounted under a cover.

### BACKGROUND

There are a variety of different methods to record and store information for later accessibility. Large amounts of information can be stored in databases or books. There is often a need, however, for maintaining easy access to smaller amount of information. There are hand held electronic devices that can be used, but these devices require that the user learn how to operate them and they can be damaged with resulting loss of the information.

Notebooks have been used to record and store information. Notebooks, however, may not be convenient to carry around in a pocket, purse, or other relatively small carrier. Notebooks can also be inconvenient for use while participating in physical activities, such as riding a bike or exercising. In addition, the notebook paper can be damaged by water and other liquids.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic front view of one embodiment of a notebook, according to the invention;

FIG. 2 is a schematic front view of the notebook of FIG. 1 with pages rotatably displaced;

FIG. 3 is a schematic front view of a second embodiment of a notebook, according to the invention; and

FIG. 4 is a schematic front view of a sheet that can be used in making pages of a notebook, according to the invention.

### DETAILED DESCRIPTION

The invention is directed to a notebook and methods of making and using the notebook. The invention is also directed to a notebook with pages rotatably mounted under a cover.

The invention includes a notebook with a cover and pages mounted within the cover. The pages are preferably rotatably attached to the cover so that, by rotation relative to the cover, the desired page or pages can be viewed. Preferably, the cover has a cutout region that facilitates engaging the pages (e.g., gripping, sliding, grasping, or otherwise moving the pages with the thumb and/or one or more fingers) to rotate the pages out of the cover. Also, preferably, one or more of the pages includes an indicia (for example, a sticker or a roughened, textured, or embossed region) on the page and aligned with the cutout region to also facilitate engaging and rotating the pages.

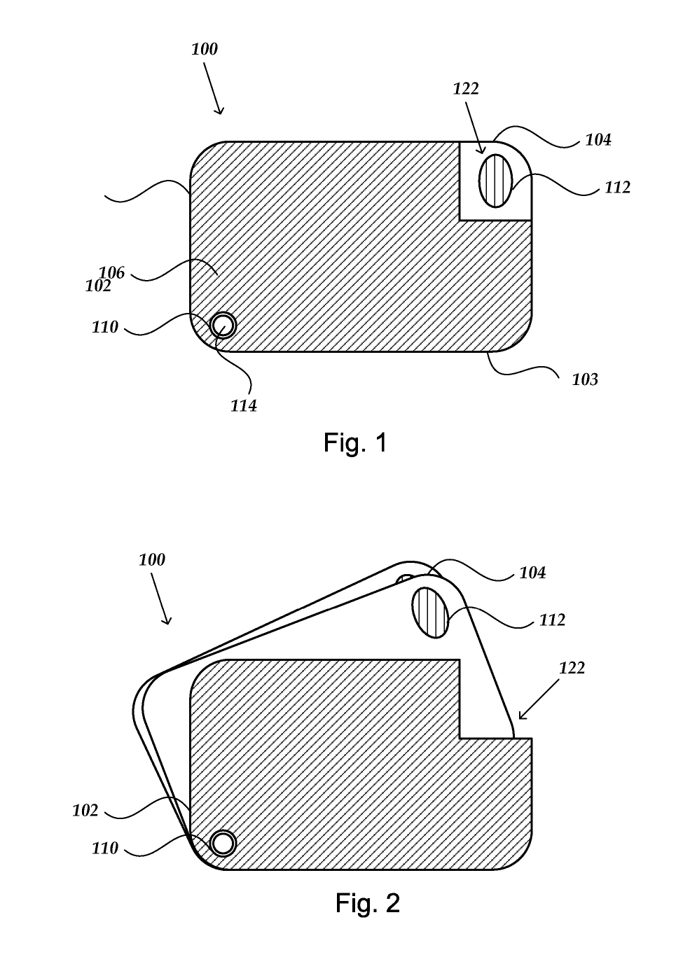

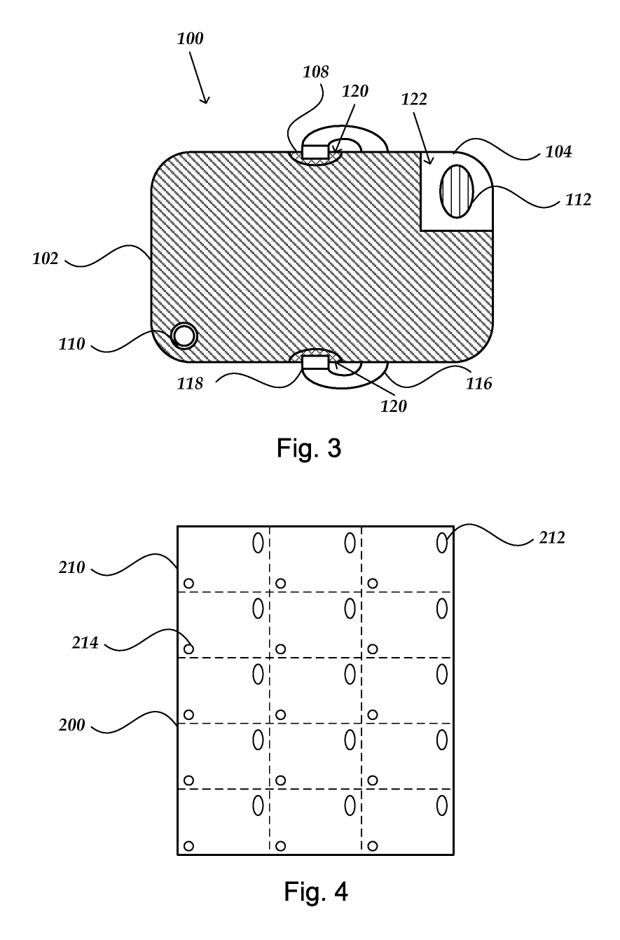

FIG. 1 illustrates one embodiment of a notebook 100 having a cover 102 and one or more pages 104. The cover 102 has a front side 106 and, optionally, a back side 108 (see FIG. 3). The pages 104 are disposed within the cover 102 and are protected by the cover. When the cover has a front and back side, the front and back side may be separate sheets or the front and back side may be a single sheet that is folded over so that the front and back side are attached along one edge 103. Alternatively, the front and back side may be affixed together along one edge using any attachment methods including, but not limited to, an adhesive, tape, application of heat, or the like.

The cover 102 can be formed of any suitable material including, but not limited to, plastic, paper (of any weight), cardboard, and laminated paper or cardboard. Preferably, the cover is made of a material that is resistant to water and cracking. The cover may be transparent, translucent, or opaque and may be clear or any color or combination of colors. In one embodiment, the cover is made of transparent or translucent plastic that can be clear or colored.

The pages 104 can be formed of any suitable material including, but not limited to, plastic, paper (of any weight), cardboard, and laminated paper or cardboard. The pages may be transparent, translucent, or opaque and may be clear or any color or combination of colors. In some embodiments, one or more of the pages can be made using a material that is rewritable and/or erasable. Such materials include paper and plastic. In one embodiment, one or more (or all) of the pages are plastic. In another embodiment, one or more (or all) of the pages are laminated media, such as laminated paper.

The cover 102 and pages 104 are held together using a fastener 110. Preferably, the fastener 110 attaches the cover and pages in one corner, as illustrated in FIG. 1, and allows the pages to be rotatably drawn out of the cover, as illustrated in FIG. 2, to permit access to and viewing of individual pages. (In some embodiments, the top page may be viewable through a clear or colored transparent cover.) In one embodiment, the fastener includes a hole through which a keychain, string, band, lanyard, cord, rope, chain, or the like can be passed to permit attachment of the notebook 100 to another object.

In one embodiment, the fastener 110 can be opened or otherwise taken apart, to allow removal and replacement of pages 104, with the subsequent reattachment (e.g., reintegration or reformation) of the fastener. For example, the fastener 110 may contain a screw that can be unscrewed to allow the removal and replacement of pages. In other embodiments, the fastener may be fixed and can not be opened or otherwise taken apart to allow replacement of pages without removing the fastener and then attaching a new fastener.

In some embodiments, where the cover has a front and back side attached along one edge 103, a portion of that edge near the fastener 110 may be slit open to allow the corners of the pages 104 to pass as the pages are rotated. As an alternative, the pages may be trimmed near the corner by the fastener to allow rotation within the cover 102.

In at least some embodiments, the front side 106 of the cover 102 has a cutout 122, preferably at a corner opposite the fastener 110, to facilitate engagement of the pages by the user and rotation of the pages 104 out of the cover. In at least some of these embodiments, one or more (preferably, all) of the pages 104 include indicia 112 that is raised or otherwise provides a textured surface that facilitates rotation of the pages out of the cover 102. The indicia may be, for example, a textured, roughened, slit, or embossed area of the page or may be sticker or other item disposed on the page.

The pages 104 of the notebook 100 can contain any type of information including text, graphics, and the like. In some embodiments, one or more of the pages can be writeable, rewritable, and/or erasable so that the content of the pages 104 can be changed by the user.

In one embodiment, one or more of the pages are made of laminated media where the content is printed on the media prior to lamination. In another embodiment, one or more of the pages have the content printed on the pages using, for example, any suitable printer (e.g., a laser or ink jet printer) or a photocopier or the like. For example, the pages can be made of plastic upon which the content has been printed using a laser printer or photocopier.

In one embodiment, a sheet 200, as illustrated in FIG. 4, is provided with one or more (preferably, all) of perforations outlining the pages 210, indicia 212, and holes 214 for the fastener. This sheet can be placed in the printer or photocopier and then the desired information can be printed on the individual pages on the sheet. The information on each page 210 can be the same of different. As one example, the same information can be printed on multiple (for example, all) pages 210 on the sheet 200. After printing, these pages 210 can be separated and then handed out to individuals attending a meeting for incorporation into a notebook or mailed to a group of individuals. It will be recognized, however, that other media can also be used in forming the pages.

Any type of content can be selected. For example, the notebook may include health or diet information, exercise information or demonstration of exercise procedures, information from a personal calendar, study material for a school class or for personal enrichment, quotes, and warning information. The notebook can be personal or can be attached to a device, machine, or any other object. For example, a notebook can be provided to a user of a machine or other device, e.g., an exercise machine or industrial machine, for personal use or the notebook can be attached to the machine or other device for consultation prior to and/or during operation of the machine or other device.

In some embodiments, the pages can contain images with lenticular or holographic images. A lenticular or holographic image can change as the observer changes position relative to the page. As one example of use, the images may depict the proper positions for use of exercise equipment through the full (or through a partial) range of motions for the exercise. In at least one embodiment, rotation of the page 104 about the fastener 110 can be used to move through the available views. Alternatively or additionally, the observer can change the relative viewing angle to move through the available views.

The notebook 100 can be any size. In one embodiment, the notebook is a suitable size for handheld use. In another embodiment, the notebook is a suitable size for storage in a pocket, purse, or other carrier. As one example, the notebook can have a size with a length of 1 to 5 inches and a width of 1 to 4 inches.

The notebook 100 can have any shape, including the rectangular shape illustrated in FIGS. 1-3. Other suitable shapes include, but are not limited to, square, circular, triangular, trapezoidal, other regular and irregular shapes, or the shapes of any item.

FIG. 3 illustrates another embodiment of the notebook 100 that contains a band 116 that attaches to the cover 102 or pages 104 for convenient attachment of the notebook 100 to a person or object, such as a car, bicycle, exercise equipment, etc. The band 116 can be, for example, a string, ribbon, cord or rope; a metal or fabric strap; an elastic strap; a strap with a VELCRO™ or other type of fastening mechanism; or a chain.

The ends of the band 116 are coupled to, preferably, the back side 108 of the cover 102 (or, alternatively, the front side 106 of the cover or one or more of the pages 104) using fasteners 118. Any type of suitable fastener can be used including, clips, adhesive, tape, rivets, and the like. In one embodiment, the front side of the cover 102 and, optionally, the pages 104 may include cutouts 120 where the band fasteners 118 are attached to the notebook 100.

In another embodiment, the band 116 forms a complete loop and is positioned so that a portion of the loop is disposed over the back side 108 (or one or more of the pages 104) and between the back side 108 and the front side 106. This portion of the band is optionally adhesively or otherwise affixed to the back side 108 (or one or more of the pages 104).

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A notebook, comprising:
a cover having a front side;
a plurality of pages disposed within the cover and rotatably coupled to the cover so that the pages can be at least partially rotated out of the cover, the front side of the cover defining a cutout that exposes a portion of the pages to allow a user to selectively engage at least one of the pages to rotate that page outside the cover.

2. The notebook of claim 1, wherein at least one of the pages comprises an indicia within the cutout defined by the front side of the cover.

3. The notebook of claim 2, wherein the indicia comprises a sticker disposed on the page.

4. The notebook of claim 2, wherein the indicia comprises a textured portion of the page.

5. The notebook of claim 4, wherein the textured portion of the page is roughened or embossed.

6. The notebook of claim 1, wherein at least one of the pages is plastic.

7. The notebook of claim 6, wherein all of the pages are plastic.

8. The notebook of claim 1, wherein at least one of the pages comprises a laminated sheet.

9. The notebook of claim 1, wherein the cover is transparent.

10. The notebook of claim 9, wherein the cover is colored.

11. The notebook of claim 1, further comprising a fastener coupling the cover and pages together.

12. The notebook of claim 11, wherein the fastener is configured and arranged to permit removal and replacement of pages without damaging the fastener.

13. The notebook of claim 12, wherein the fastener comprises a screw arrangement that can be unscrewed to permit removal and replacement of pages.

14. The notebook of claim 1, further comprising a band coupled to at least one of the cover or pages.

15. A notebook, comprising:
a cover having a front side and a back side;
a plurality of pages disposed within the cover; and
a band coupled to opposing edges of the cover and disposed around the back side of the cover to permit attachment of the notebook to an object.

16. The notebook of claim 15, wherein the front side of the cover defines a plurality of cutouts for attachment of the band to the back side of the cover or at least one of the pages.

17. The notebook of claim 16, wherein at least one of the pages defines a plurality of cutouts for attachment of the band to the back side of the cover or at least one of the pages.

18. The notebook of claim 15, wherein the band comprises a fastening mechanism.

19. The notebook of claim 15, wherein the band is an elastic band.

20. A method of making a notebook, comprising:
printing information on at least one notebook page disposed on a sheet, the sheet comprising perforation defining a plurality of notebook pages, indicia disposed on each of the notebook pages, and a hole defined through each of the notebook pages;
removing, from the sheet, the at least one notebook page with the printed information; and
disposing the at least one notebook page into a notebook.
